(19) United States
(12) Patent Application Publication
(10) Pub. No.: US 2026/0336982 A1
(43) Pub. Date: Oct. 29, 2026

(54) DOOR GAP REDUCTION OF AN ELEVATOR SYSTEM

(71) Applicant: Inventio AG, Hergiswil (CH)

(72) Inventor: Marcel Ackermann, Kirchberg SG (CH)

(21) Appl. No.: 19/114,495

(22) PCT Filed: Sep. 11, 2023
(86) PCT No.: PCT/EP2023/074848

§ 371 Date: Mar. 24, 2025

(30) Foreign Application Priority Data
Sep. 30, 2022 (EP) 22198910.6

(51) Int. Cl. B66B 13/30; B66B 13/12

(52) U.S. Cl. CPC B66B 13/301; B66B 13/12

(57) ABSTRACT

An elevator system includes a car, with a car door having a car door panel and a car door threshold, and a shaft door having a shaft door panel and a shaft door threshold. A coupling mechanism has a car door coupling connected to the car door panel and a shaft door coupling connected to the shaft door panel, which couplings cooperate to move the shaft door panel and the car door panel together. A first door gap reduction element bridges the door gap between the car door threshold and the shaft door threshold and is displaced in a displacement direction parallel to the direction of displacement of the car door panel between the closed position and the open position. Thus, the first door gap reduction element can be shifted between a ready-for-crossing position and a ready-for-travel position.

### FIELD

The present invention relates to an elevator system and to a method for operating the elevator system.

### BACKGROUND

In an elevator system, a car is typically moved vertically along a travel path between different floors or levels within a building. The car has doors to enable loading and unloading or entering and leaving. The doors include car doors that close the car off from the shaft, and shaft doors that close a floor off from the shaft. The car doors and the shaft doors are opened simultaneously provided the car is on the same floor and thereby allow access to the interior of the car.

In order for the car doors and the shaft doors to open simultaneously, they are typically connected by a coupling mechanism. If the car is at a floor, the coupling mechanism couples the car door to the shaft door. Generally the car door is the one that is driven by a motor, and the shaft door is entrained by the coupling mechanism. The coupling mechanism usually includes a shaft door coupling on the shaft door and a car door coupling on the car door.

In order to have sufficient safety distance for the car to pass the floor, the car door threshold and the shaft door threshold are arranged with a door gap between them. This door gap is still present when the car is being loaded or entered. This can, for example, cause spike heels to get trapped or break off in the door gap. For example, hospital beds are also shaken while crossing the door gap, which can cause pain to the patient.

U.S. Pat. No. 8,540,058 B2 discloses a car door threshold that has pass-through regions. The otherwise narrow door gap becomes wider at these pass-through regions to allow the shaft door couplings to pass. At a stop at a floor, the pass-through region is closed by a folding body.

This solution is complex to implement because it includes many components. The folding body is moved in the same direction in which it is loaded during entering. This means that a drive for the folding movement must be able to generate large forces in order to move the folding body. Such a solution is therefore expensive.

An object can therefore be considered of providing a simpler and more economical door gap reduction element.

### SUMMARY

According to a first aspect of the invention, the object is achieved by an elevator system. The elevator system comprises a car and a car door arranged on the car, having a car door panel and a car door threshold. The car door threshold guides the car door panel linearly between a closed position and an open position. The elevator system further comprises a shaft door having a shaft door panel, and the shaft door has a shaft door threshold that guides the shaft door panel linearly between a closed position and an open position. The elevator system further comprises a coupling mechanism which has a car door coupling which is connected to the car door panel, and a shaft door coupling which is connected to the shaft door panel. The car door coupling and the shaft door coupling can be coupled to one another in order to move the shaft door panel and the car door panel together. The elevator system further comprises a first door gap reduction element which bridges the door gap between the car door threshold and the shaft door threshold. The first door gap reduction element can be displaced in a displacement direction which is parallel to the direction of displacement of the car door panel between the closed position and the open position. This allows the first door gap reduction element to be displaced between a ready-for-crossing and a ready-for-travel position. A second door gap reduction element is arranged on the shaft door threshold or on the car door threshold and can be displaced linearly. A door gap reduction element stop is securely attached to the car between the first door gap reduction element and the second door gap reduction element.

According to a second aspect of the invention, the object is achieved by a method for operating an elevator system according to the first aspect of the invention. The method has the following steps:

shifting the first door gap reduction element from the ready-for-crossing position to the ready-for-travel position,
moving the car of the elevator system with the first door gap reduction element in the ready-for-travel position, and
shifting the first door gap reduction element from the ready-for-travel position to the ready-for-crossing position, and
loading and/or unloading the car with the first door gap reduction element in the ready-for-crossing position.

Possible features and advantages of embodiments of the invention can be regarded, inter alia and without limiting the invention, as being based upon the concepts and findings described below.

The coupling mechanism has a car door coupling and a shaft door coupling. The car door coupling is connected to the car door panel. The shaft door coupling is connected to the shaft door panel. The car door coupling typically has a pair of runners that are spreadably arranged on the car door panel. The shaft door coupling typically has a few rollers. To couple the shaft door coupling to the car door coupling, the runners move between the rollers and spread there so that the rollers are contacted by the runners. As a result, the shaft door coupling and the car door coupling are now coupled together. This means that the shaft door panel and the car door panel move together.

So that the car door coupling and the shaft door coupling can engage with each other during coupling, they are mounted in such a way that they can engage with each other in an engagement region. This means that the car door coupling extends beyond the car door threshold in a projection onto a horizontal plane, and the shaft door coupling extends beyond the shaft door threshold in the projection onto the horizontal plane. Both extend so far that the car door coupling and the shaft door coupling can engage with each other, and the region of this engagement forms the engagement region. The engagement region is at a distance from the car door threshold so that the shaft door coupling does not touch the car door threshold during travel. In addition, the engagement region is also at a distance from the shaft door threshold so that the car door coupling does not touch the shaft threshold during travel. The thickness of the engagement region therefore influences the distance between the car door threshold and the shaft door threshold and therefore the width of the door gap.

The first door gap reduction element is located on the car or on the shaft. Preferably, the first door gap reduction element is attached to the car door or to the car door threshold or to the shaft door or to the shaft door threshold. Alternatively, it can be attached to another support structure on the car, for example below the car door threshold. Furthermore, it can be attached to another support structure, for example directly to the shaft wall on the shaft.

The car door threshold or the shaft door threshold refer to the fixed part of the car door or the shaft door which serves to guide the car door panel or the shaft door panel.

Preferably, the first door gap reduction element is arranged on the car door threshold or the shaft door threshold.

The car door threshold maintains a distance from the shaft door threshold so that the car can travel without touching objects arranged in the shaft. Such objects can be, for example, the shaft door coupling or the shaft door threshold. Conversely, the shaft door threshold maintains a distance from the car door threshold so that the car can travel without objects arranged in the shaft touching the car.

Car door thresholds and shaft door thresholds preferably have a straight-line design. This creates a continuous door gap, the minimum width of which is determined by the space required for the car door coupling and the shaft door coupling. A door gap distance can therefore be bridged by means of the first door gap reduction element. The first door gap reduction element is designed to be movable laterally, i.e. parallel to the direction of displacement of the sliding doors, in order to be able to reduce the entire width of the door gap by means of the first door gap reduction element when the car is stopped at the floor and in a ready-for-crossing position. When the car is moved, i.e. in the ready-for-travel position, the engagement region can pass.

The door gap is reduced by attaching a first door gap reduction element, preferably on the car door threshold or on the shaft door threshold. In the ready-for-crossing position, the first door gap reduction element extends at least over a portion of the width or preferably over the entire width of the opened door. This means that the door gap in the portion of the opened door is reduced. Preferably, the door gap is reduced across the entire door width, in particular with no gap. This means the doorway is can be passed through. The door gap significantly reduced by the first door gap reduction element can be driven over with little vibration and walked on safely.

For reaching the ready-for-travel position, the first door gap reduction element can be shifted to the side along a linear guide so that the entire door gap distance of the door gap, i.e. from the car door threshold to the shaft door threshold, is opened up for a portion of the width of the opened door. In this ready-for-travel position, the car can be moved so that the first door gap reduction element on the car door and the car door threshold can safely pass the shaft door coupling during travel, or so that the first door gap reduction element on the shaft door and the shaft door threshold can be safely passed by the car door coupling.

The first door gap reduction element is preferably mounted on a linear guide so as to be linearly movable. This can preferably be a rail on which the first door gap reduction element is mounted by preferably a plurality of linear guides. These guides can be ball bearings, roller bearings or plain bearings. A plurality of linear guides can also guide the first door gap reduction element so that torque occurring at the first door gap reduction element due to the load from being driven over or walked on can be absorbed as a pair of forces by the plurality of linear guides.

It is particularly advantageous that the first door gap reduction element can be shifted horizontally. The first door gap reduction element is stressed substantially in the vertical direction by the first door gap reduction element being walked on or driven over. These forces are essentially absorbed by the bearing of the first door gap reduction element. In particular, these forces act perpendicular to the direction of displacement of the first door gap reduction element.

Preferably, the second door gap reduction element is arranged on the same component as the first door gap reduction element, i.e. for example also on the car, the car door threshold, the shaft or the shaft door threshold.

Preferably, the first and second door gap reduction elements are guided on the same linear guide or on the same linear guides. Alternatively, the first door gap reduction element and the second door gap reduction element can each be guided via a separate linear guide or a plurality of separate linear guides.

The door gap reduction element stop fills a region between the first door gap reduction element and the second door gap reduction element that is not needed as a region of passage. This reduces the distance that the first or second door gap reduction element is moved from the ready-for-crossing position to the ready-for-travel position. Preferably, in the ready-for-crossing position, the first door gap reduction element touches the door gap reduction element stop on one side, and the second door gap reduction element touches the door gap reduction element stop on the opposite side.

The door gap reduction element stop allows two pass-through regions that are separate from each other to be opened up at a car door threshold or at a shaft door threshold.

Regardless of whether only a first door gap reduction element, a first and a second door gap reduction element or a first and a second door gap reduction element and a door gap reduction element stop are used, in the ready-for-crossing position, a continuous door gap reduction element preferably extends over the entire width of the opened door.

The method for operating an elevator system comprises a first step in which the first door gap reduction element is shifted from the ready-for-crossing position to the ready-for-travel position. This step is preferably carried out during the closing process of the doors. Preferably, this should be started as late as possible so that the first door gap reduction element remains in the passable position as long as a passenger is able to enter or leave the car through the closing doors. This shift can be ended when the car starts moving, or it can continue after the car starts moving or accelerating. The shifting is preferably completed before the first door gap reduction element passes a car door coupling or a shaft door coupling for the first time. At this point at the latest, the first door gap reduction element must be in the ready-for-travel position so that the first door gap reduction element does not collide with the car door coupling or the shaft door coupling. Preferably, the first door gap reduction element is already in the ready-for-travel position at the start of travel, i.e. when the car begins to accelerate.

In a second step, the car of the elevator system with the first door gap reduction element in the ready-for-travel position is moved.

Travel can be over a plurality of floors. A first door gap reduction element attached to the car door threshold can pass one or more shaft door couplings. Alternatively, a car door coupling can pass one or more first door gap reduction elements attached to the shaft door thresholds.

In a third step, the first door gap reduction element is shifted from the ready-for-travel position to the ready-for-crossing position. Preferably, the first door gap reduction element is entirely in the ready-for-crossing position as soon as the door begins to open. If the door gap reduction elements are attached to the shaft door thresholds, preferably only the door gap reduction element will be shifted to the ready-for-crossing position which is located on the floor at which the car has stopped.

In a fourth step, the car is loaded and/or unloaded with the first door gap reduction element in the ready-for-crossing position. This means that people enter the car or leave the car. Alternatively, goods can also be loaded into or removed from the car.

After the fourth step, a first step preferably follows again for initiating the next travel of the car.

According to a preferred embodiment, the method comprises the step of:
beginning of shifting the first door gap reduction element from the ready-for-travel to the ready-for-crossing position after the first door gap reduction element of the traveling car has passed the last of the shaft door couplings or car door couplings to be passed.

The time at which the last of the shaft door couplings or car door couplings to be passed are passed is the earliest possible time for shifting the first door gap reduction element back towards the ready-for-crossing position. Collisions would occur if the shifting were earlier. The first door gap reduction element can thus be shifted with a lower displacement speed and/or the first door gap reduction element be in the ready-for-crossing position earlier.

According to a preferred embodiment, the method comprises the step of:
completing the shift of the first door gap reduction element from the ready-for-travel position to the ready-for-crossing position before or at the time at which the car door reaches the open position.

The time at which the car door reaches the open position corresponds to the latest possible time at which the ready-for-crossing position should optimally be reached. This in turn allows the first door gap reduction element to be shifted more slowly. Alternatively, the shift of the first door gap reduction element from the ready-for-travel to the ready-for-crossing position can also be completed before the opening of the car door begins.

According to a preferred embodiment of the elevator system, the first door gap reduction element in the ready-for-crossing position at least partially bridges a door gap between a walk-on area on the car door threshold and a walk-on area on the shaft door threshold.

The shaft door threshold, the car door threshold and the first door gap reduction element can be walked on. They therefore have a walk-on area that can be walked on. If the car is at a floor, the walk-on areas should preferably be in the same plane. The walk-on area is preferably designed to be anti-slip, i.e. texturized or with an anti-slip coating. In addition, the door threshold can have grooves to guide the door panels. The grooves can be placed in the top, bottom or front of the respective door threshold.

According to a preferred embodiment of the elevator system, the first door gap reduction element in the ready-for-travel position opens up a pass-through region through which the shaft door coupling or the car door coupling is moved during car travel.

The pass-through region is therefore opened up in the direction in which the car door or the shaft door move next to the first door gap reduction element. The pass-through region is opened up by shifting the first door gap reduction element away from a region in which the pass-through region is formed by the away movement. The pass-through region creates space in the door gap to allow the shaft door coupling to pass if the first door gap reduction element is arranged on the car, or it creates space in the door gap to allow the car door coupling to pass if the first door gap reduction element is arranged on the shaft door. A plurality of door couplings can also travel through the pass-through region of a door gap reduction element attached to the shaft door if the elevator has plurality of cars. A plurality of shaft door couplings travel through the pass-through region of a door gap reduction element attached to the car door if more than two floors are reached by the car.

According to a preferred embodiment of the elevator system, the second door gap reduction element shifts in the opposite direction of the first door gap reduction element.

Preferably, the two door gap reduction elements shift away from each other during the shift from the ready-for-crossing position to the ready-for-travel position and towards each other during the shift from the ready-for-travel position to the ready-for-crossing position. In the ready-for-crossing position, the first door gap reduction element can touch the second door gap reduction element. A pass-through region is opened up between the first door gap reduction element and the second door gap reduction element. This can advantageously be twice as large with the same displacement speed of the door gap reduction elements. Alternatively, the displacement speed of the two door gap reduction elements can be halved to create a pass-through region of equal width.

In an alternative embodiment of the elevator system, a door gap reduction element stop is securely attached to the car in addition to the first door gap reduction element. In this case the only pass-through region opens between the first door gap reduction element and the door gap reduction element stop.

The door gap reduction element stop can be designed as an integral component of the car door threshold or of the shaft door threshold. Alternatively, the first door gap reduction element, the second door gap reduction element and the door gap reduction element stop are preferably made from a single profile. The profile can be a rolled or extruded metal profile. Cut pieces of the profile can, as a door gap reduction element stops, be permanently connected to the car or the shaft door or, in particular, to the car door threshold or the shaft door threshold. Other cut pieces of the profile can be arranged as a first or second door gap reduction element via linear guides on the car or on the shaft door or, in particular, on the car door threshold or on the shaft door threshold.

According to a preferred embodiment of the elevator system, the first door gap reduction element has a drive which shifts the first and/or the second door gap reduction elements along the car door threshold or the shaft door threshold between the ready-for-crossing position and the ready-for-travel position.

The drive can, for example, drive via a driven first roller a traction means which runs over the first roller and a second roller. The traction means moves the first door gap reduction element and optionally the second door gap reduction element. Alternatively, a spindle drive can drive the first and the second door gap reduction elements. In this case, the spindle drive for the two sides preferably has an opposite pitch of the spindle so that the driven door gap reduction elements each move in opposite directions.

According to a preferred embodiment of the elevator system, the first door gap reduction element can be locked in the ready-for-crossing position by a retaining element.

It is advantageous for both door gap reduction elements to be locked in the ready-for-crossing position under an applied pushing force along the linear guides and not be able to be displaced. This means that the first or second door gap reduction element cannot slide along the linear guides when being walked on. Such a slide would be dangerous and could lead to accidents. The retaining element can be a latch or a bolt. Such a latch or bolt can preferably be unlocked by an actuator. Alternatively, the retaining element can also be designed as a brake which is released upon each displacement of the door gap reduction element, and otherwise preferably always brakes.

The spindle drive can also take on the function of the retaining element. For example, it can preferably be designed to be self-locking. This means that the door gap reduction element can be moved by turning the spindle, but a force in the direction of the linear guides on the first or second door gap reduction element causes so much friction on the spindle that the movement is locked. Alternatively however, the spindle or the drive of the spindle can have a brake, a latch or a bolt that locks the door gap reduction elements in the ready-for-crossing position.

According to a preferred embodiment of the elevator system, a first sensor reports to a control unit that the first door gap reduction element is in the ready-for-crossing position, and/or a second sensor reports to the control unit that the first door gap reduction element is in the ready-for-travel position.

Preferably, a third sensor reports to the control unit that the second door gap reduction element is in the ready-for-crossing position, and/or a fourth sensor reports to the control unit that the second door gap reduction element is in the ready-for-travel position.

According to a preferred embodiment of the elevator system, the first door gap reduction element is arranged on the car so as to be linearly displaceable between a ready-for-crossing position and a ready-for-travel position.

When the first door gap reduction element is arranged on the car, only one car needs to have a first door gap reduction element. This is cheaper than equipping all shaft doors with door gap reduction elements. Even if the elevator system has plurality of cars, this advantage remains.

According to a preferred embodiment of the elevator system, the first door gap reduction element reduces the door gap distance between the car door threshold and the shaft door threshold to a residual distance, and the residual distance is a maximum of half the door gap distance.

The door gap distance is therefore the distance between the car door threshold preferably immovably attached to the car, and the shaft door threshold attached to the shaft door or shaft. The door gap is then reduced by the first door gap reduction element arranged in the door gap.

The residual distance is therefore less than half of the door gap. This means that vibrations can be greatly reduced, for example when hospital beds are crossing. Additionally, the risk of for example walking sticks or spike heels getting stuck can be prevented.

Further advantages, features, and details of the invention can be found in the following description of embodiments and with reference to the drawings, in which like or functionally like elements are provided with identical reference signs. The drawings are merely schematic and are not to scale.

### DESCRIPTION OF THE DRAWINGS

In the figures:

FIG. 1 shows a preferred embodiment in horizontal section with centrally closing telescopic door panels in the ready-for-travel position with closed doors,

FIG. 2 shows the embodiment from FIG. 1 in ready-for-crossing position, but still with closed doors,

FIG. 3 shows the embodiment of FIG. 1 in ready-for-crossing position with open doors,

FIG. 4 shows the embodiment and the configuration as in FIG. 1 in an isometric view of the car door,

FIG. 5 shows the embodiment and configuration as in FIG. 3 in an isometric view of the car door,

FIG. 6 shows an embodiment with only one car door panel and one shaft door panel in the ready-for-crossing position with open door,

FIG. 7 shows the embodiment from FIG. 6 in ready-for-travel position with closed door,

FIG. 8 shows the embodiment from FIG. 6 in a side view, and

FIG. 9 shows an alternative embodiment with the first door gap reduction element on the shaft doors.

### DETAILED DESCRIPTION

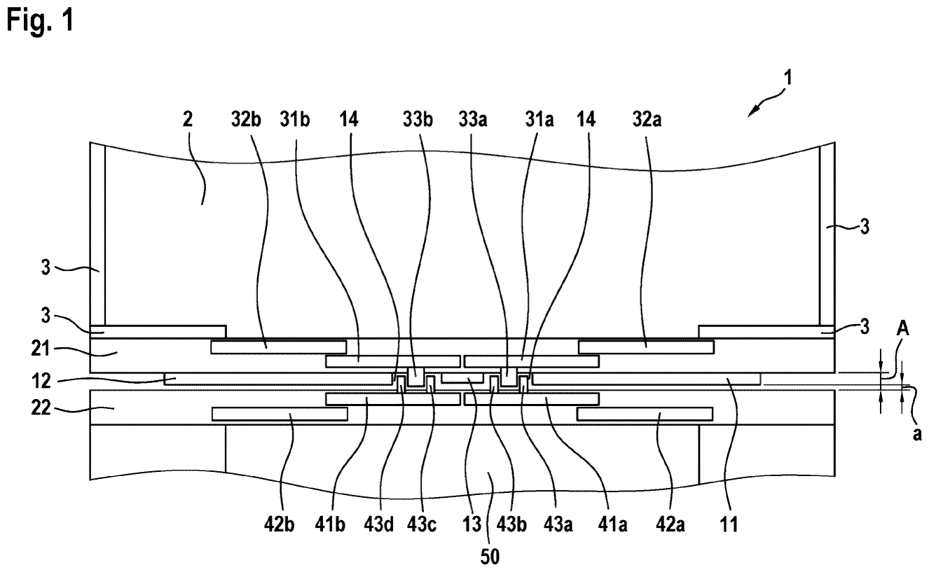

FIG. 1 shows in a horizontal section an elevator system 1 with a car 2 that has stopped at a floor. The car walls 3 close off the car 2 from the shaft. The floor surface of floor 50 and the floor surface of the car are at the same height. The elevator system 1 has a centrally closing car door with the car door panels 31a, 31b, 32a and 32b. The car door panels 31a, 31b, 32a and 32b are guided on the car door threshold 21. The elevator system 1 has a centrally closing shaft door symmetrical to the car door with the shaft door panels 41a, 41b, 42a and 42b. The shaft door panels 41a, 41b, 42a and 42b are guided on the shaft door threshold 22.

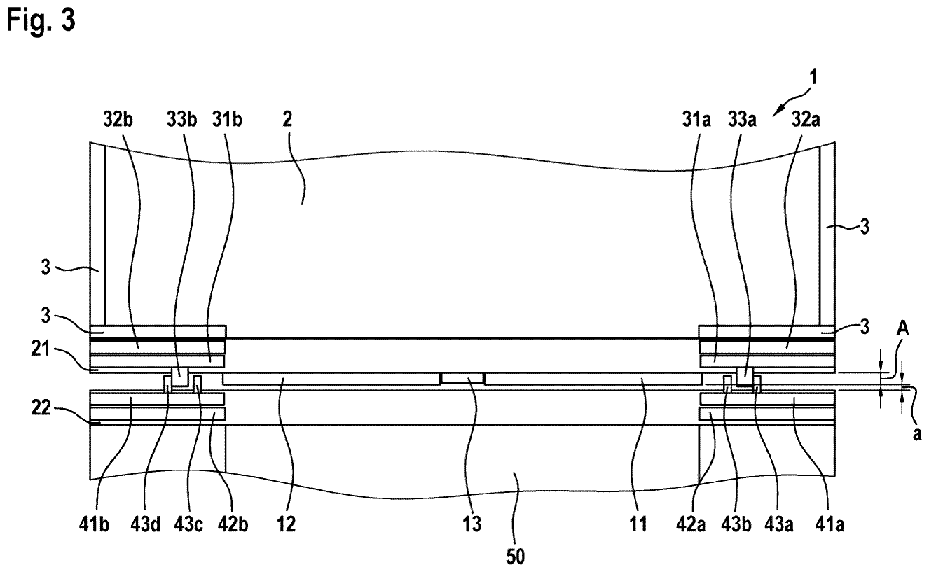

The car door panels 31a and 31b move, driven by a door drive (not shown), twice as fast as the slower car door panels 32a and 32b. When a first car door panel 31a opens, a first car door coupling 33a attached thereto entrains the opposite first shaft door coupling 43a and 43b. FIG. 3 shows the doors in the open position. The car door coupling 33a touches the shaft door coupling 43a and 43b in such a way that the shaft door 41a is held in the open position together with the coupled shaft door 42a. A door closing device (not shown) counteracts this and pushes the shaft door panels 41a, 41b, 42a and 42b towards the closed position. Analogously, the second car door coupling 33b touches the second shaft door coupling 43c and 43d in such a way that the shaft door 41b is held in the open position together with the coupled shaft door 42b.

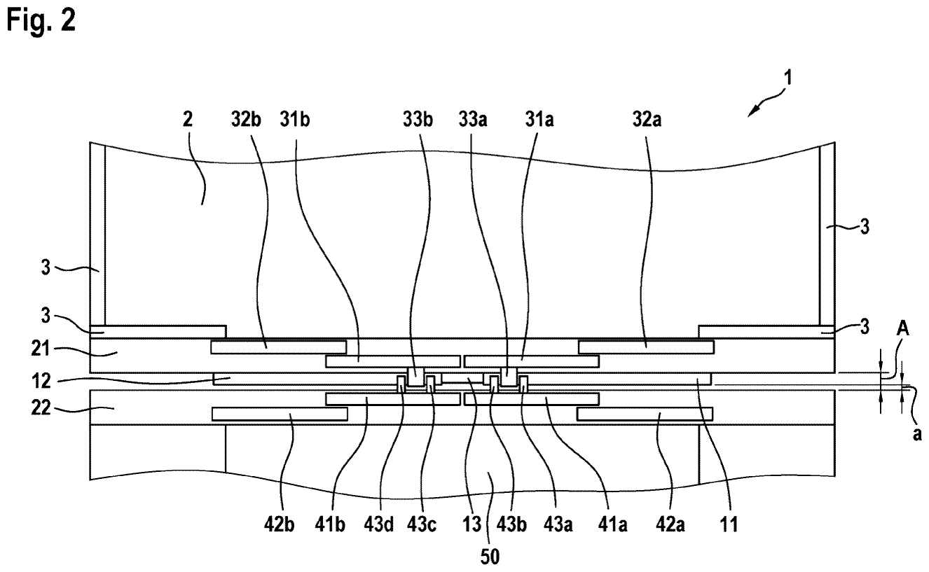

The first door gap reduction element 11, the second door gap reduction element 12 and the door gap reduction element stop 13 are mounted in the door gap between the car door threshold 21 and the shaft door threshold 22. In this case, both door gap reduction elements 11, 12 and the door gap reduction element stop 13 reduce the door gap distance A to a residual distance a. In the ready-for-crossing position of the two door gap reduction elements as shown in FIGS. 2 and 3, the user only has to cross or travel over the residual distance a. FIG. 1 shows how the displacement of the two door gap reduction elements 11 and 12 opens up a pass-through region 14. Between the door gap reduction element stop 13 and the first door gap reduction element 11, a pass-through region 14 is opened up for the first shaft door coupling 43a and 43b. Between the door gap reduction element stop 13 and the second door gap reduction element 12, a pass-through region 14 is opened up for the second shaft door coupling 43c and 43d. In FIG. 1, there is a safety distance between all components of the car and the shaft, which ensures the safe travel of the car 2. FIG. 2 shows a state in which the car 2 has just reached the floor. The door gap reduction elements 11 and 12 have already been moved into the ready-for-crossing position, but the door panels 31a, 31b, 32a, 32b, 41a, 41b, 42a and 42b have not yet been opened. Continuing travel with the door gap reduction elements 11 and 12 in this position could destroy the shaft door couplings 43a, 43b, 43c and 43d. The embodiment shown in FIGS. 1, 2 and 3 is a preferred embodiment which is preferably used in hospitals to transport patients in bed into an elevator with as little vibration as possible. The door gap reduction elements 11 and 12 and the door gap reduction element stop 13 extend seamlessly over the entire width of the open door in the ready-for-crossing position.

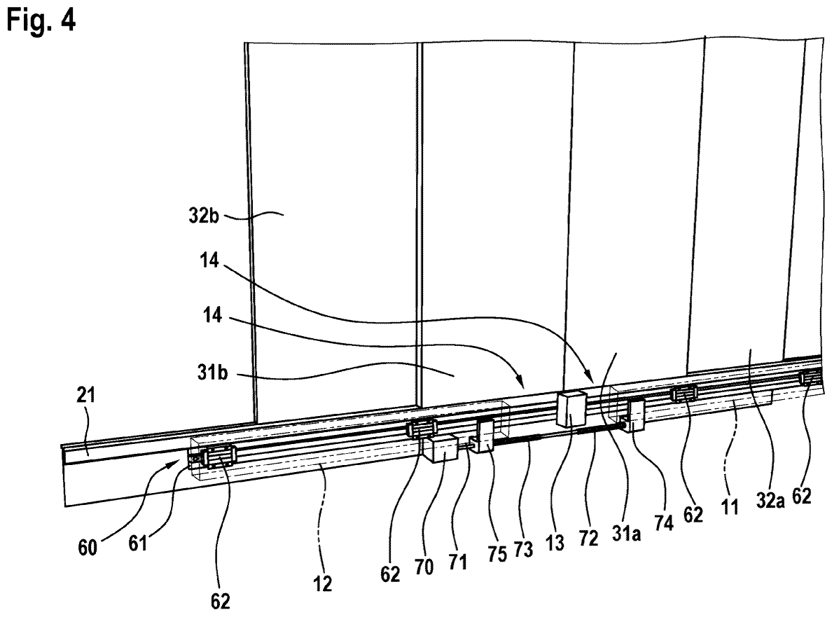

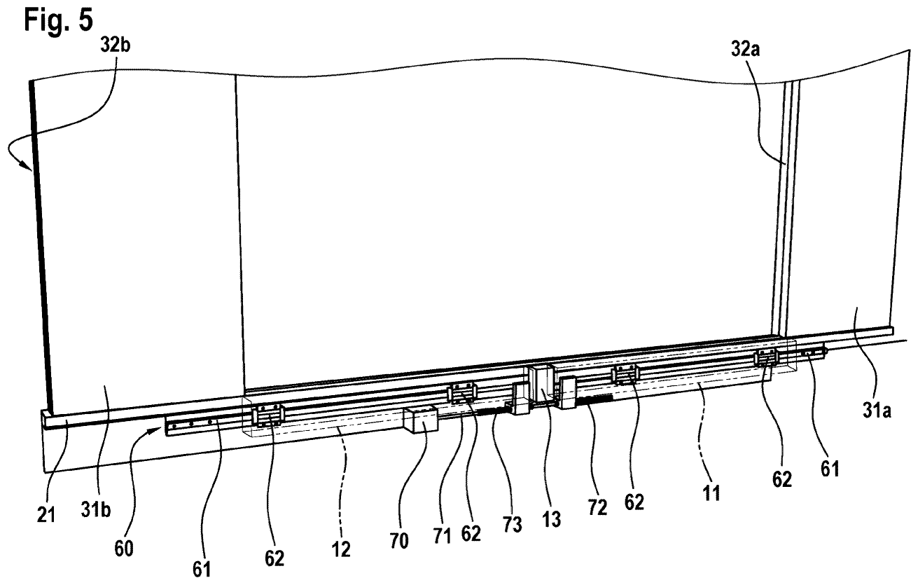

FIGS. 4 and 5 show the car door of the embodiment in FIG. 1, FIG. 2 and FIG. 3 in an isometric view. FIG. 4 shows the door panels 31a, 31b, 32a and 32b in the closed position and the door gap reduction elements 11 and 12 in the ready-for-travel position. FIG. 5 shows the door panels 31a, 31b, 32a and 32b in the open position and the door gap reduction elements 11 and 12 in the ready-for-crossing position. The car door threshold 21 forms a walk-on area at the top and forms a fastening option for the linear guide 60 at the bottom. The linear guide 60 comprises a linear guide rail 61. The movable door gap reduction elements 11 and 12 are shown transparently so that the guide bodies 62 can be seen. The first door gap reduction element 11 and the second door gap reduction element 12 are each mounted on the linear guide rail 61 via two guide bodies 62.

The drive 70 rotates a spindle via a shaft 71. The spindle includes a first spindle region 72 which works together with a first spindle nut 74 and, when the spindle rotates, moves the first door gap reduction element 11. The spindle also comprises a second spindle region 73 which works together with a second spindle nut 75 and, when the spindle rotates, moves the second door gap reduction element 12. The thread orientation of the spindle regions 72 and 73 is opposite, so that a rotation of the spindle in one direction leads to movements of the first door gap reduction element 11 and the second door gap reduction element 12 which run in opposite directions to each other. In addition, the pitch of the spindle regions 71 and 72 is so small that the door gap reduction elements 11 and 12 can only be moved by the rotation of the spindle, but not by forces on the door gap reduction elements 11 and 12, even if these forces are applied in the direction of displacement. The spindle is therefore self-locking and therefore locks the first door gap reduction element 11 and the second door gap reduction element 12 in the ready-for-crossing position.

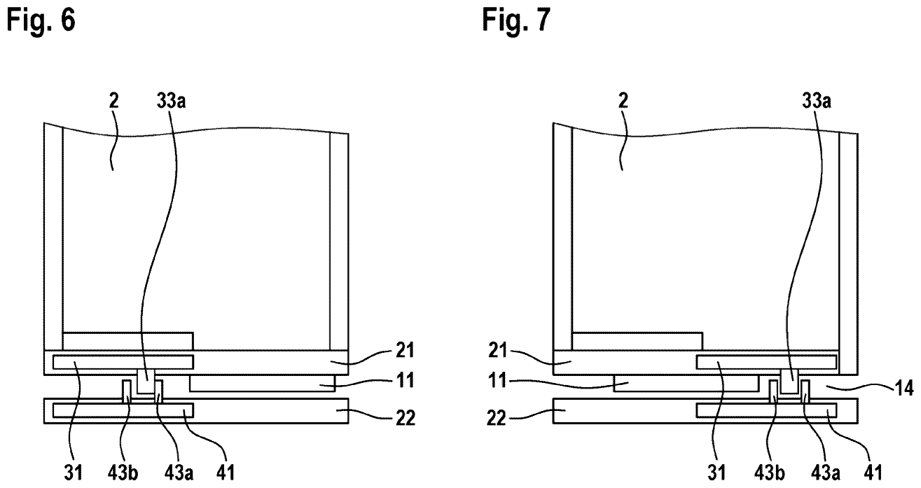

FIGS. 6 and 7 show a minimal embodiment of the invention. The first door gap reduction element 11 can be moved in the door gap between the shaft door threshold 22 and the car door threshold 21 so that a pass-through region is created, as in FIG. 5. The car door has only one car door panel 31, and the shaft door has only one shaft door panel 41. When the car 2 is traveling, the pass-through region 14, which is opened up by the first door gap reduction element 11 attached to the car 2, allows the shaft door couplings 43a and 43b to be passed on all floors without touching them.

FIG. 6 shows the first door gap reduction element 11 in the ready-for-crossing position with the doors open. The door gap reduction element 11 extends over the entire width of the open door. FIG. 7 shows the ready-for-travel position with the door closed.

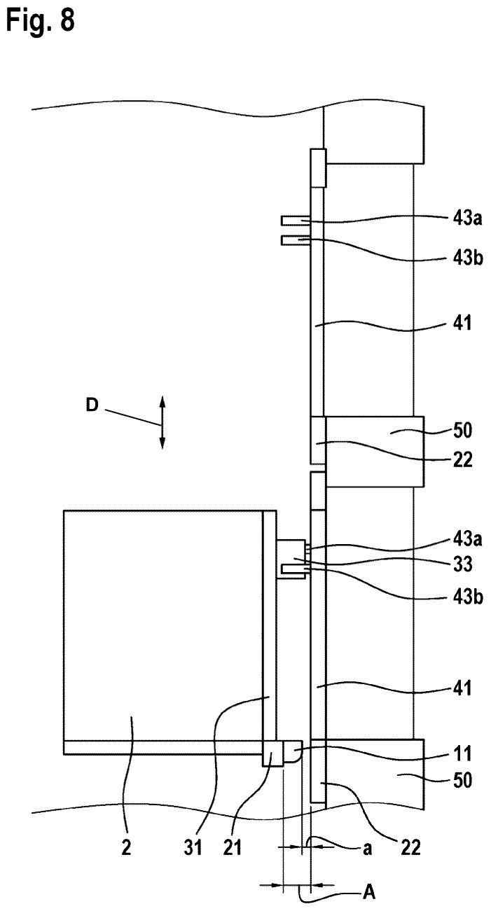

FIG. 8 shows a side view of the embodiment from FIGS. 6 and 7. The car 2 can travel in the directions of the drawn double arrow D. The first door threshold 11 is arranged on the car door threshold 21 of the car 2. This has the advantage that only the car 2 has a door gap reduction element.

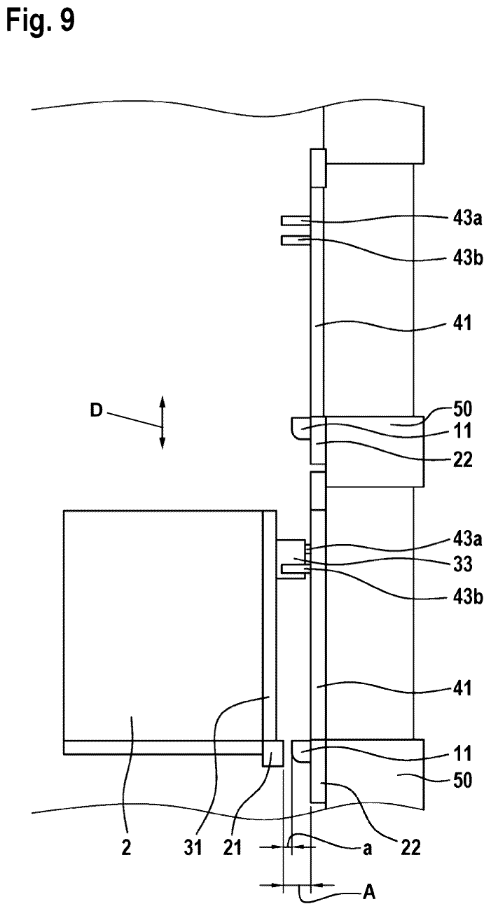

FIG. 9 shows a side view of an alternative embodiment that is similar to the embodiment in FIG. 6, FIG. 7 and FIG. 8. However, in the embodiment in FIG. 9, the door gap reduction elements 11 are attached to the shaft door thresholds 22 instead of to the car door threshold 21. This reduces the load on the car door threshold 21.

FIG. 8 and FIG. 9 both show that the car door coupling 33 is attached to the car door panel 31, and that the shaft door coupling 43a and 43b is attached to the respective shaft door panel 41 on all floors. The shaft door panel 41 is guided along the shaft door threshold 22.

Finally, it should be noted that terms such as “having,” “comprising,” etc., do not preclude other elements or steps, and terms such as “a” or “one” do not preclude a plurality. Furthermore, it should be noted that features or steps which have been described with reference to one of the above exemplary embodiments may also be used in combination with other features or steps of other exemplary embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. An elevator system comprising:
a car;
a car door arranged on the car with a car door panel, the car having a car door threshold that guides the car door panel moving linearly between a closed position and an open position of the car door;
a shaft door with a shaft door panel arranged at a shaft door threshold, the shaft door threshold guiding the shaft door panel moving linearly between a closed position and an open position of the shaft door;
a coupling mechanism including a car door coupling connected to the car door panel and a shaft door coupling connected to the shaft door panel, wherein the car door coupling and the shaft door coupling are adapted to couple to one another to move the shaft door panel and the car door panel together;
a first door gap reduction element bridging a door gap between the car door threshold and shaft door threshold when the car door threshold is adjacent the shaft door threshold;
wherein the first door gap reduction element is shiftable in a displacement direction parallel to a direction of displacement of the car door panel between the closed position and the open position of the car door, the first door gap reduction element being shiftable between a ready-for-crossing position and a ready-for-travel position;
a second door gap reduction element arranged on the shaft door threshold or on the car door threshold and being shiftable linearly; and
a door gap reduction element stop attached to the car between the first door gap reduction element and the second door gap reduction element.

15. The elevator system according to claim 14 wherein the first door gap reduction element is arranged on the car.

16. The elevator system according to claim 14 wherein the first door gap reduction element in the ready-for-crossing position at least partially bridges the door gap between a walk-on area on the car door threshold and a walk-on area on the shaft door threshold.

17. The elevator system according to claim 14 wherein the first door gap reduction element in the ready-for-travel position opens up a pass-through region through which the shaft door coupling or the car door coupling is moved when the car is traveling.

18. The elevator system according to claim 14 wherein the first door gap reduction element reduces a door gap distance between the car door threshold and the shaft door threshold to a residual distance, the residual distance being a maximum of half the door gap distance.

19. The elevator system according to claim 14 wherein the second door gap reduction element moves in a direction opposite a direction in which the first door gap reduction element is moving.

20. The elevator system according to claim 14 including a drive that shifts the first door gap reduction element along the car door threshold or along the shaft door threshold between the ready-for-crossing position and the ready-for-travel position.

21. The elevator system according to claim 14 including a retaining element locking the first door gap reduction element against movement in the ready-for-crossing position.

22. The elevator system according to claim 21 wherein the retaining element includes a spindle drive that that shifts the first door gap reduction element between the ready-for-crossing position and the ready-for-travel position.

23. A method for operating an elevator system, the elevator system including a car with a car door and a shaft with a shaft door, the method comprising steps of:
shifting a first door gap reduction element in the shaft from a ready-for-crossing position to the ready-for-travel position;
moving the car in the shaft to the shaft door with the first door gap reduction element in the ready-for-travel position;
shifting the first door gap reduction element from the ready-for-travel position to the ready-for-crossing position; and
loading and/or unloading the car at the shaft door with the first door gap reduction element in the ready-for-crossing position.

24. The method according to claim 23 including starting the shifting of the first door gap reduction element from the ready-for-travel position to the ready-for-crossing position after the first door gap reduction element has passed a last shaft door coupling or car door coupling to be passed before the car arrives at the shaft door.

25. The method according to claim 24 including completing the shifting of the first door gap reduction element from the ready-for-travel position to the ready-for-crossing position before or at a time when the car door reaches an open position.

26. The elevator system according to claim 23 including sensing and reporting to a control unit that the first door gap reduction element is in the ready-for-crossing position and/or that the first door gap reduction element is in the ready-for-travel position.
